(19) United States
(12) Patent Application Publication
(10) Pub. No.: US 2026/0222409 A1
(43) Pub. Date: Jul. 30, 2026

(54) HIGH PERFORMANCE PROXY FOR NETWORK DEVICES FOR ZERO-TRUST NETWORK ACCESS (ZTNA) AND SECURE INTERNET GATEWAY (SIG)

(71) Applicant: Cisco Technology, Inc., San Jose, CA (US)

(72) Inventors: George Mathew Koikara, Bangalore (IN); Gowri Dhandapani, Boise, ID (US); Nishanth Srikanth Bhat, Bengaluru (IN); Harsh Kumar Sharma, Jaipur (IN)

(21) Appl. No.: 19/037,043

(22) Filed: Jan. 24, 2025

(51) Int. Cl. H04L 9/40

(52) U.S. Cl. CPC H04L 63/101; H04L 63/08

(57) ABSTRACT

Techniques for eliminating double encryption of network traffic between client(s) and protected service(s) based on transport mechanisms utilized by the client(s) and the protected service(s) are disclosed herein. A client-based proxy executing on a client device may receive a request from a browser executing on the client device to access a protected service associated with a network, and the client proxy may intercept the connection of the browser to the service. A gateway associated with the service may require a user of the browser to be authenticated for access to the protected service, and following authentication, the gateway may send a token to the client proxy. Based on whether traffic between the browser and the protected service is transmitted according to a secure transport mechanism, the client proxy may establish one of an unencrypted connection or an encrypted connection with the gateway, and access of the browser may be resumed.

### TECHNICAL FIELD

The present disclosure relates generally to eliminating double encryption of network traffic between client(s) and protected service(s) based on transport mechanisms utilized by the client(s) and the protected service(s).

### BACKGROUND

In a networking environment, there generally are multiple proxies operating at the L4, L5 and L7 layers of the open systems interconnection (OSI) stack. At the L4 layer, the protocols do not support any means of authenticating the connection. Transport layer security (TLS) proxies operate at the L5 layer, while hypertext transport protocol (HTTP) or other application proxies operate at the L7 layer. Most of the session context and authentication is usually done at the L7 layer by using HTTP cookies in the case of HTTP connections (or other application specific authorization mechanisms). In the case of application traffic that is protected by TLS, the TLS layer has to first process the connection involving cryptographic operations and then pass the plain text to the application layers. The TLS operations involved are computationally expensive and in the case of attacks, the server can be overwhelmed with such computation leading to a denial of service to valid clients.

Additionally, traffic sent from a client application (e.g., a browser) is typically sent to a gateway via an encrypted tunnel, where the outer encryption helps to hide the destination sent in the server name indication (SNI) field in the TLS connection. Therefore, to an observer, the traffic is always destined to the gateway, but which services are accessed behind the gateway would remain unknown since the payload in the outer tunnel (having the internal TLS session) is encrypted. Adding the outer encryption layer may be warranted if the application traffic is not encrypted. However, if the application traffic is already encrypted (e.g., with hypertext transport protocol secure (HTTPS), secure shell (SSH), and/or the like) the additional compute and resources required for adding and/or removing the outer encryption layer may outweigh the benefits it offers. This additional overhead may be incurred by both the client and the gateway. This is a known problem in the industry.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example network and a protected service (or application) that may be accessed by a browser of the network, in accordance with the techniques described herein.

FIG. 2A illustrates a first portion of an example flow diagram of an example method for eliminating double encryption in zero-trust network access (ZTNA) and/or secure internet gateway (SIG) authenticated sessions, in accordance with the techniques described herein.

FIG. 2B illustrates a second portion of the example flow diagram of the example method for eliminating double encryption in zero-trust network access (ZTNA) and/or secure internet gateway (SIG) authenticated sessions, in accordance with the techniques described herein.

FIG. 3 illustrates a flow diagram of an example method for eliminating double encryption of network traffic between client(s) and protected service(s) based on transport mechanisms utilized by the client(s) and the protected service(s).

FIG. 4 illustrates a flow diagram of another example method for eliminating double encryption of network traffic between client(s) and protected service(s) based on transport mechanisms utilized by the client(s) and the protected service(s).

FIG. 5 illustrates a block diagram illustrating an example packet switching system that can be utilized to implement various aspects of the technologies disclosed herein.

FIG. 6 illustrates a block diagram illustrating certain components of an example node that can be utilized to implement various aspects of the technologies disclosed herein.

FIG. 7 illustrates a computing system diagram illustrating a configuration for a data center that can be utilized to implement aspects of the technologies disclosed herein.

FIG. 8 is a computer architecture diagram showing an illustrative computer hardware architecture for implementing a server device that can be utilized to implement aspects of the various technologies presented herein.

### DESCRIPTION OF EXAMPLE EMBODIMENTS

### Overview

This disclosure describes method(s) for eliminating double encryption of network traffic between client(s) and protected service(s) based on transport mechanisms utilized by the client(s) and the protected service(s). The method includes receiving, by a client-based proxy executing on a user device and from a browser executing on the user device, a request to access a protected service associated with a network. Additionally, or alternatively, the method includes stalling, by the client-based proxy, access of the browser to the protected service. Additionally, or alternatively, the method includes authenticating, by the client-based proxy, a user of the browser for access to the protected service. Additionally, or alternatively, the method includes receiving, based at least in part on authenticating the user of the browser, a token from a gateway associated with the network. Additionally, or alternatively, the method includes determining, by the endpoint client-based proxy, whether traffic between the browser and the protected service is transmitted according to a secure transport mechanism. Additionally, or alternatively, the method includes based at least in part on determining whether traffic between the browser and the protected service is transmitted according to the secure transport mechanism, establishing, by the client-based proxy and based at least in part on the token, a transport control protocol (TCP) connection (or a uniform datagram protocol (UDP) connection) between the client-based proxy and the gateway. In some examples, the TCP connection may be utilized to transmit the traffic between the browser and the protected service. Additionally, or alternatively, the method includes based at least in part on determining whether traffic between the browser and the protected service is transmitted according to the secure transport mechanism, establishing a transport layer secure (TLS) connection between the client-based proxy and the gateway to transmit the traffic between the browser and the protected service. Additionally, or alternatively, the method includes resuming, by the client-based proxy, access of the browser to the protected service.

Additionally, or alternatively, the method includes receiving, from an application executing on a user device, a request to access a protected service associated with a network. Additionally, or alternatively, the method includes intercepting, by a client-based proxy associated with the user device, access of the application to the protected service. Additionally, or alternatively, the method includes receiving, based at least in part on authenticating a user of the application, a token from a gateway associated with the network. Additionally, or alternatively, the method includes determining whether traffic between the application and the protected service is transmitted according to a secure transport mechanism. Additionally, or alternatively, the method includes based at least in part on determining whether traffic between the application and the protected service is transmitted according to a secure transport mechanism, one of establishing an unencrypted connection between the client-based proxy and the gateway to transmit the traffic between the application and the protected service or establishing an encrypted connection between the client-based proxy and the gateway to transmit the traffic between the application and the protected service. Additionally, or alternatively, the method includes allowing, by the client-based proxy, access of the application to the protected service.

Additionally, the techniques described herein may be performed by a system and/or device having non-transitory computer-readable media storing computer-executable instructions that, when executed by one or more processors, performs the method described above.

### EXAMPLE EMBODIMENTS

As previously described, when encrypted traffic needs to be inspected by an intermediate gateway, the application traffic may be decrypted, inspected, and re-encrypted before passing the traffic to the application server. When outer encryption is added by the client to encrypted application traffic as described above, there are two levels of decryption to be done by the gateway, a first to access the application traffic, and a second for decrypting the actual application traffic. This double decryption operation is expensive, as a single level of decryption may impact performance by 40-50%, effectively reducing performance by almost 60-75% when double encryption is involved. Similarly, in the reverse direction, the gateway needs to re-encrypt the application traffic after inspection and then add the outer encryption before sending it back to the client. Ultimately, the two encryption and/or decryption operations result in lower performance of the network. This disclosure describes techniques for eliminating double encryption of network traffic between client(s) and protected service(s). In particular, the techniques may provide for eliminating double encryption of network traffic in zero-trust network access (ZTNA) and/or secure internet gateway (SIG) sessions between client(s) and protected service(s) based on transport mechanisms utilized by the client(s) and the protected service(s). For example, when an application that is protected by a gateway is accessed, the gateway and/or a client-based proxy may determine whether to establish an encrypted connection (e.g., a TLS connection) for transmitting traffic between the application and the client or establish an unencrypted connection (e.g., a TCP connection or a UDP connection) for transmitting the traffic between the application and the client based on whether or not the application and/or the client utilize a secure transport mechanism (e.g., HTTPS, SSH, and/or the like) to transport the traffic.

In some examples, a “protected service” may be an application that is configured behind a network gateway, such as, for example, an enterprise gateway. Additionally, or alternatively, a gateway may be configured as a firewall and/or any other network proxy capable of authenticating users and/or inspecting traffic if configured to. An endpoint client and/or a client-based proxy may execute on an endpoint device and correspond to a client-based proxy which may be configured to establish a tunnel to the gateway. The endpoint device may also execute a browser and/or any other application. The endpoint devices may be onboarded with an enterprise associated with the gateway and/or the protected service, and the client devices may have a certificate which may be utilized to authenticate the endpoint and/or the user of the endpoint. Additionally, or alternatively, the endpoint devices may have the client-based proxy software installed thereon. The client-based proxy may be configured with information indicating which services are protected services. In some examples, an identity provider (IdP) may be leveraged to authenticate the users for access to the protected service provisioned behind the gateway.

Take, for example, a client device onboarded with an enterprise. In some examples, a user of the client device may wish to access a protected service associated with the enterprise and/or configured as a protected service with respect to a network associated with the enterprise (e.g., an enterprise network). In some examples, the private service may be accessible by the client device via an application, such as, for example, a browser. For example, a user may utilize the browser of the client device to navigate to a protected service (e.g., “protectedservice.com”). In some examples, the request to access the protected service from the browser may be intercepted by the client proxy software executing on the client device. That is, the client proxy may intercept the access request from the browser, masquerading as the protected service. The client proxy may then complete a TCP 3-way handshake (3WHS) with the client device. Additionally, or alternatively, the browser may send a client hello (CH) to the client proxy. Following receipt of the CH from the browser, the client proxy may then “stall” or otherwise intercept the connection.

The client proxy may be configured to initiate a mutual TLS (mTLS) control connection with the gateway in order to authenticate the user for the request protected service. For example, the client proxy may initiate the mTLS control connection with the gateway using a client device certificate to authenticate the hardware of the client device. Additionally, or alternatively, the client proxy may request an authentication check for the requested protected service. In some examples, a protected service may require authentication of the user of the client device before the gateway may grant the client device access to the protected service. For example, the gateway may perform a policy lookup for the requested protected service and/or the user of the client device to determine whether authentication of the user is required. In examples where authentication of the user is required, the gateway may redirect the client proxy and/or the client device to an IdP for authentication. For example, the gateway may send data to the client proxy causing the client device to launch a browser (e.g., another tab, another window, an embedded browser, and/or the like) with a security assertion markup language (SAML) request. The client proxy may then exchange data with the IdP to authenticate the user of the client device. In some examples, authentication of the user may comprise one or more authentication requirements (e.g., multi-factor authentication (MFA)). Once the authentication requirement(s) are satisfied, the browser may return an authentication response, including a SAML response or an AuthZ token, to the client proxy, where the client proxy may pass the authentication response to the gateway via the control channel.

The gateway may be configured to validate the AuthZ token and may evaluate the configured policy for access to the application. In some examples, the gateway may perform a policy lookup to determine whether the request protected service is already protected with a secure transport mechanism (e.g., HTTPS, SSH, and/or any other encrypted protocol). Additionally, or alternatively, the gateway may determine if the requested protected service needs to be inspected by an intrusion detection service (IDS) and/or an intrusion prevention service (IPS). That is, the gateway may determine, based on a policy, whether traffic between the client device and the protected service is transmitted according to a secure transport mechanism and/or whether the traffic between the client device and the protected service needs to be inspected by an IDS and/or an IPS.

Once the policy lookup is completed, the gateway may generate a nonce and/or a set of pre-shared keys (PSKs) and the gateway may send the nonce and the PSK(s) to the client proxy via the mTLS control connection. The client proxy may receive the PSK(s) and/or the nonce and the client proxy may establish a new TCP connection to the gateway. That is, the client proxy may determine a PSK of the set of PSKs to utilize for the establishment of the new TCP connection. Since the application traffic is encrypted, no outer encryption may be required from this point on between the client and the gateway.

The client proxy may send a CH to the gateway with the SNI pointing to the gateway. In some examples, the nonce received from the gateway and/or the original CH received from the browser may be encrypted with the PSK and included with the CH as TLS extension(s). Additionally, or alternatively, the encryption may be done with a private key of the client proxy, in which case a public key of the client proxy may be included as a TLS extension.

Additionally, or alternatively, instead of using an encrypted CH including the original CH as TLS extension(s), the SNI token may be utilized to obfuscate the destination. For example, the gateway may generate a unique SNI token corresponding to the destination and return the SNI token to the client proxy as part of the control connection. In some examples, the SNI token may be required to have the same length as that of the original SNI. The SNI token may ensure that an attacker does not see the actual destination being accessed behind the gateway. For example, the client and/or server application(s) may utilize the original SNI for sending communications, and the client proxy and/or gateway may rewrite the original SNI in the communications to an SNI token, and vice-versa. That is, when the client proxy and/or the gateway receive an SNI token, they may rewrite the original SNI before sending to the client and/or server application.

The gateway may receive the CH and ensure the integrity of the client proxy by decrypting the nonce with the PSK and/or the public key of the client proxy and validating it. In some examples, the gateway may retrieve the original CH from the browser and send the original CH to the application server hosting the protected service on a new TCP connection. The gateway may then receive a response from the application server including a server hello (SH). When the gateway receives the SH from the application server, the gateway may be configured to construct a new SH. In some examples, the new SH may be encrypted (e.g., using the PSK and/or a private key of the gateway) and/or may include the original SH as a TLS extension. The gateway may then send the new SH to the client proxy.

The client proxy may receive the new SH from the gateway and may be configured to restore the original SH (e.g., by decrypting the TLS extension) and forward the original SH to the browser. Additionally, or alternatively, the connection with the browser may be resumed by the client proxy. Then, the TLS handshake between the browser and the application server associated with the protected service may be completed. It should be understood that all sensitive parameters (including the SNI) transmitted between the client browser and the application server are encrypted until the handshakes are completed, thus there is no concern of leaking sensitive information. Subsequently, the client proxy and/or the gateway may switch to being a TCP proxy, taking payload from the client-side connection and writing to the server-side connection and vice-versa.

In examples where the application (client application and/or protected service) does not use a secure transport mechanism, such as, for example, HTTP, the client proxy may need to create an encrypted tunnel to secure the communication to the gateway. For example, the gateway would be configured to decrypt the outer tunnel, retrieve the payload, and send the payload to the server. Additionally, or alternatively, in the reverse direction, the gateway may receive plain traffic from the server and send the traffic back to the client proxy on the encrypted tunnel. In some examples, the client proxy may decrypt the outer tunnel and may send clear (e.g., unencrypted) traffic from the server to the client application (e.g., the browser).

Additionally, or alternatively, in examples where application traffic needs to be inspected on the gateway, the inner encryption may be between the client application (e.g., the browser) and the gateway. The gateway would be configured to decrypt the traffic, perform inspect, re-encrypt the traffic, and send the traffic to the server. Additionally, or alternatively, the connections carrying data between the client proxy and the gateway may be optimized by using session resumption tickets that may be exchanged as a part of the control connection.

As described herein, a computing-based, network-based, cloud-based service, network device, can generally include any type of resources implemented by virtualization techniques, such as containers, virtual machines, virtual storage, and so forth. Further, although the techniques described as being implemented in data centers and/or a cloud computing network, the techniques are generally applicable for any network of devices managed by any entity where virtual resources are provisioned. In some instances, the techniques may be performed by a schedulers or orchestrator, and in other examples, various components may be used in a system to perform the techniques described herein. The devices and components by which the techniques are performed herein are a matter of implementation, and the techniques described are not limited to any specific architecture or implementation.

The techniques described herein provide various improvements and efficiencies with respect to eliminating double encryption and/or decryption operations of network traffic between client(s) and protected service(s) based on transport mechanisms utilized by the client(s) and the protected service(s). For instance, authentication may happen in the control connection and data may be exchanged in the data connections. By separating the control and data connections, this allows the data connections to be distributed among multiple enforcement paths if the deployment allows for it, leading to increased network performance even in equal-cost multipath (ECMP) routing. Moreover, the exchange of sensitive information happens on the encryption control connection and any sensitive fields in the data connections, such as, for example, the SNI, the server certificate, and/or the like, are encrypted, which increases network security as none of this information will be susceptible to a leak, as attackers do not see which services are protected by the gateway. Further, if application traffic is encrypted no outer encryption is added, and if application traffic is plain then an outer encryption layer is added between the client proxy and the gateway. That is, there is only ever one level of encryption involved, resulting reduced computational costs and complexity by both the client proxy and the gateway. This always may improve latency and throughput and allow for much higher scaling when compared to using double encryption. Additionally, such techniques may be applied in zero-trust network access (ZTNA) and/or secure internet gateway (SIG) use cases.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

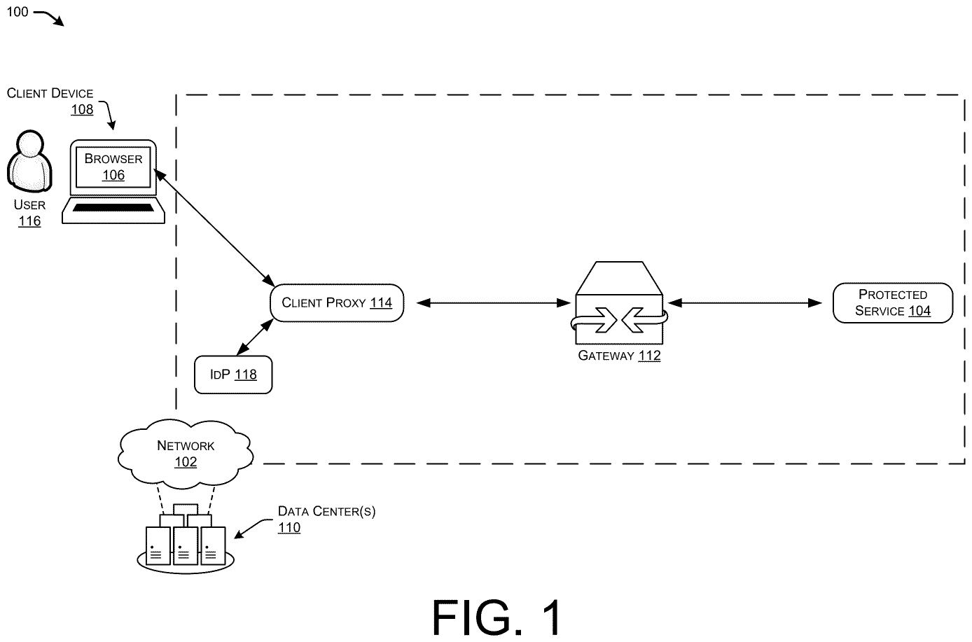

FIG. 1 illustrates a system-architecture diagram 100 of an example network 102 and a protected service (or a server application) 104 that may be accessed by a client application, such as, for example, a browser 106 executing on a client device 108, in accordance with the techniques described herein.

Generally, the network 102 may include devices that are housed or located in one or more data centers 110 that may be located at different physical locations. For instance, the network 102 may be supported by networks of devices in a public cloud computing platform, a private/enterprise computing platform, and/or any combination thereof. The one or more data centers 110 may be physical facilities or buildings located across geographic areas that are designated to store networked devices that are part of the network 102. The data centers 110 may include various networking devices, as well as redundant or backup components and infrastructure for power supply, data communications connections, environmental controls, and various security devices. In some examples, the data centers 110 may include one or more virtual data centers which are a pool or collection of cloud infrastructure resources specifically designed for enterprise needs, and/or for cloud-based service provider needs. Generally, the data centers 110 (physical and/or virtual) may provide basic resources such as processor (CPU), memory (RAM), storage (disk), and networking (bandwidth). However, in some examples the devices in the network 102 may not be located in explicitly defined data centers 110 and, rather, may be located in other locations or buildings.

In some examples, a protected service 104 may be an application that is configured behind a network gateway 112, such as, for example, an enterprise gateway 112. Additionally, or alternatively, a gateway 112 may be configured as a firewall and/or any other network proxy capable of authenticating users and/or inspecting traffic if configured to. An endpoint client and/or a client-based proxy 114 may execute on the client device 108 and correspond to a client-based proxy 114 which may be configured to establish a tunnel to the gateway 112. The client device 108 may also execute a browser 106 and/or any other application. Client devices 108 may be onboarded with an enterprise associated with the gateway 112 and/or the protected service 104, and the client devices 108 may have a certificate which may be utilized to authenticate the client device 108 and/or a user 116 of the client device 108. Additionally, or alternatively, the client devices 108 may have the client-based proxy 114 software installed thereon. The client-based proxy 114 may be configured with information indicating which services are protected services 104. In some examples, an identity provider (IdP) 118 may be leveraged to authenticate the user(s) 116 for access to the protected service 104 provisioned behind the gateway 112.

In some examples, when an application that is protected by the gateway 112 is accessed, the gateway 112 and/or a client-based proxy 114 may determine whether to establish an encrypted connection (e.g., a TLS connection) for transmitting traffic between the protected application 104 and the client 108 or establish an unencrypted connection (e.g., a TCP connection or a UDP connection) for transmitting the traffic between the protected application 104 and the client 108 based on whether or not the protected application 104 and/or the client 108 utilize a secure transport mechanism (e.g., HTTPS, SSH, and/or the like) to transport the traffic.

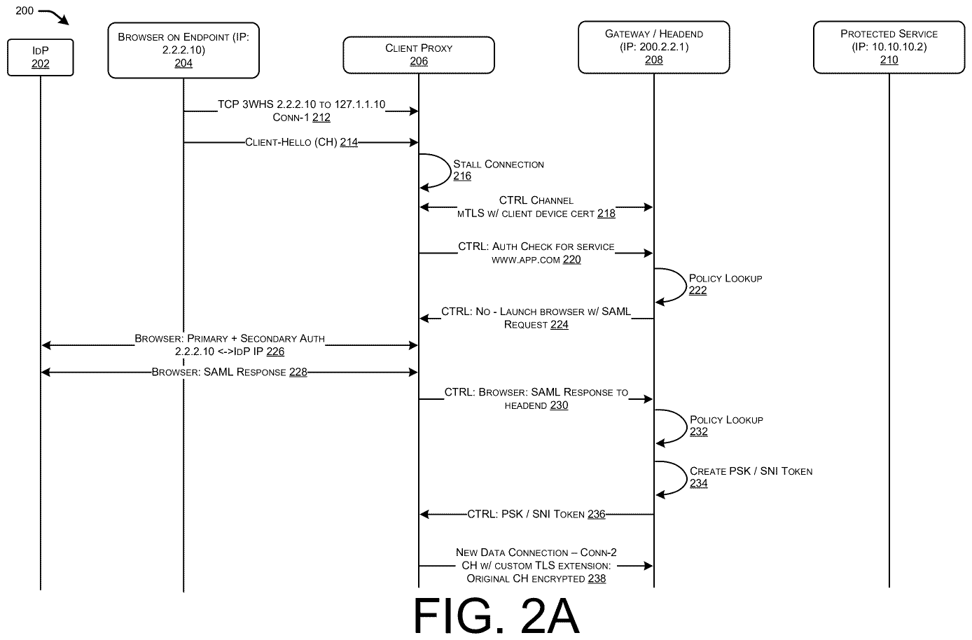

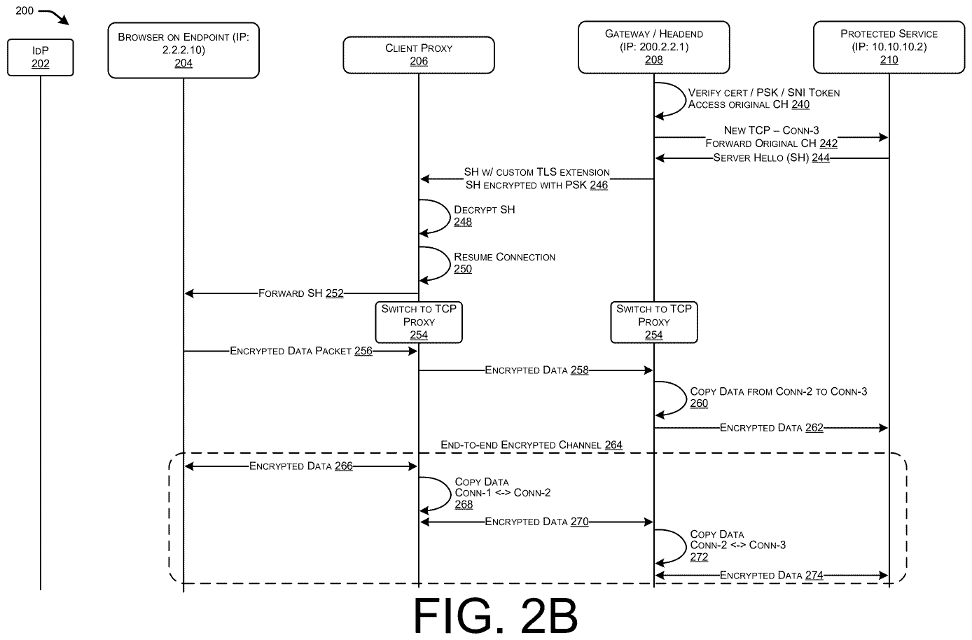

FIGS. 2A and 2B collectively illustrate an example flow diagram of an example method 200 for eliminating double encryption in zero-trust network access (ZTNA) and/or secure internet gateway (SIG) authenticated sessions, in accordance with the techniques described herein. The flow diagram illustrated by FIGS. 2A and 2B include various communications and/or operations performed by and/or between an IdP 202, a client application, such as, for example, a browser on a client endpoint 204, a client proxy 206, a gateway 208, and/or a protected service 210. In some examples, the IdP 202, the browser 204, the client proxy 206, the gateway 208, and/or the protected service 210 may correspond to the IdP 118, the browser 106, the client proxy 114, the gateway 112, and/or the protected service 104, as described with respect to FIG. 1. That is, FIGS. 2A and 2B illustrate an example flow diagram of the example method 200 for eliminating double encryption and/or decryption which may be performed by any number of the components depicted by the system-architecture diagram 100, as illustrated in FIG. 1.

Turning to FIG. 2A, the method 200 may begin at 212, where a user of a client device that has been onboarded with an enterprise may wish to access a protected service 210 associated with the enterprise and/or configured as a protected service 210 with respect to a network associated with the enterprise (e.g., an enterprise network). In some examples, the protected service 210 may be accessible by the client device via an application, such as, for example, a browser 204. For example, a user may utilize the browser 204 of the client device to navigate to a protected service 210 (e.g., “protectedservice.com”). In some examples, the request to access the protected service 210 from the browser 204 may be intercepted by the client proxy 206 software executing on the client device. That is, the client proxy 206 may intercept the access request from the browser 204, masquerading as the protected service 210. The client proxy 206 may then complete a TCP 3-way handshake (3WHS) with the client device.

At 214, the browser 204 may send a client hello (CH) to the client proxy 206. At 216, following receipt of the CH from the browser 204, the client proxy 206 may then “stall” or otherwise intercept the connection.

At 218, the client proxy 206 may be configured to initiate a mutual TLS (mTLS) control connection with the gateway 208 in order to authenticate the user for the request protected service 210. For example, the client proxy 206 may initiate the mTLS control connection with the gateway 208 using a client device certificate to authenticate the hardware of the client device. Additionally, or alternatively, at 220, the client proxy 206 may request an authentication check for the requested protected service 210. In some examples, a protected service 210 may require authentication of the user of the client device before the gateway 208 may grant the client device access to the protected service 210. For example, at 222, the gateway 208 may perform a policy lookup for the requested protected service 210 and/or the user of the client device to determine whether authentication of the user is required. At 224, it may be determined that authentication of the user is required, and the gateway 208 may redirect the client proxy 206 and/or the client device to an IdP 202 for authentication. For example, the gateway 208 may send data to the client proxy 206 causing the client device to launch a browser 204 (e.g., another tab, another window, an embedded browser, and/or the like) with a security assertion markup language (SAML) request. At 226, the client proxy 206 may then exchange data with the IdP 202 to authenticate the user of the client device. In some examples, authentication of the user may comprise one or more authentication requirements (e.g., multi-factor authentication (MFA)). Once the authentication requirement(s) are satisfied, at 228, the browser 204 may return an authentication response, including a SAML response or an AuthZ token, to the client proxy 206, where at 230 the client proxy 206 may pass the authentication response to the gateway 208 via the control channel.

The gateway 208 may be configured to validate the AuthZ token and may evaluate the configured policy for access to the protected application 210. At 232, the gateway 208 may perform a policy lookup to determine whether the request protected service 210 is already protected with a secure transport mechanism (e.g., HTTPS, SSH, and/or any other encrypted protocol). Additionally, or alternatively, the gateway 208 may determine if the requested protected service 210 needs to be inspected by an intrusion detection service (IDS) and/or an intrusion prevention service (IPS). That is, the gateway 208 may determine, based on a policy, whether traffic between the client device and the protected service 210 is transmitted according to a secure transport mechanism and/or whether the traffic between the client device and the protected service 210 needs to be inspected by an IDS and/or an IPS.

At 234, once the policy lookup is completed, the gateway 208 may generate a nonce and/or a set of pre-shared keys (PSKs) and at 236, the gateway 208 may send the nonce and the PSK(s) to the client proxy 206 via the mTLS control connection. At 238, the client proxy 206 may receive the PSK(s) and/or the nonce and the client proxy 206 may establish a new TCP connection to the gateway 208. That is, the client proxy 206 may determine a PSK of the set of PSKs to utilize for the establishment of the new TCP connection. In examples where the application traffic is encrypted, no outer encryption may be required from this point on between the client proxy 206 and the gateway 208.

The client proxy 206 may send a CH to the gateway 208 over the new TCP connection with the SNI pointing to the gateway 208. In some examples, the nonce received from the gateway 208 and/or the original CH received from the browser 204 may be encrypted with the PSK and included with the CH as TLS extension(s). Additionally, or alternatively, the encryption may be done with a private key of the client proxy 206, in which case a public key of the client proxy 206 may be included as a TLS extension.

Additionally, or alternatively, instead of using an encrypted CH including the original CH as TLS extension(s), the SNI token may be utilized to obfuscate the destination. For example, at 234, the gateway 208 may generate a unique SNI token corresponding to the destination and at 236, the gateway may return the SNI token to the client proxy 206 as part of the control connection. In some examples, the SNI token may be required to have the same length as that of the original SNI. The SNI token may ensure that an attacker does not see the actual destination (e.g., protected service 210) being accessed behind the gateway 208. For example, the client application (e.g., browser 204) and/or the server application (e.g., protected service 210) may utilize the original SNI for sending communications, and the client proxy 206 and/or gateway 208 may rewrite the original SNI in the communications to an SNI token, and vice-versa. That is, when the client proxy 206 and/or the gateway 208 receive an SNI token, they may rewrite the original SNI before sending to the browser 204 and/or the protected service 210.

Turning to FIG. 2B, the method 200 may continue at 240, where the gateway 208 may receive the CH and ensure the integrity of the client proxy 206 by decrypting the nonce with the PSK and/or the public key of the client proxy 206 and validating it. At 242, the gateway 208 may retrieve the original CH from the browser 204 and send the original CH to the application server hosting the protected service 210 on a new TCP connection. At 244, the gateway 208 may receive a response from the application server including a server hello (SH). When the gateway 208 receives the SH from the application server, the gateway 208 may be configured to construct a new SH. In some examples, the new SH may be encrypted (e.g., using the PSK and/or a private key of the gateway 208) and/or may include the original SH as a TLS extension. At 246, the gateway 208 may then send the new SH to the client proxy 206.

At 248, the client proxy 206 may receive the new SH from the gateway 208 and may be configured to restore the original SH (e.g., by decrypting the TLS extension). At 250, the connection with the browser 204 may be resumed by the client proxy 206, and at 252, the original SH may be forwarded from the client proxy 206 to the browser 204. That is, the SH received by the browser 204 was received directly from the application server hosting the protected service 210, without any tampering of the SH. As a result, the TLS handshake between the browser 204 and the application server associated with the protected service 210 may be completed. It should be understood that all sensitive parameters (including the SNI) transmitted between the client browser 204 and the application server are encrypted until the handshakes are completed, thus there is no concern of leaking sensitive information. At 254, the client proxy 206 and/or the gateway 208 may switch to being a TCP proxy (or a UDP proxy in examples where UDP connections are utilized), taking payload from the client-side connection and writing to the server-side connection and vice-versa.

At 256, the browser sends an encrypted data packet to the client proxy 206, and at 258, the client proxy 206 may forward the encrypted data to the gateway 208. At 260, the gateway 208 may copy the data from the connection between the client proxy 206 and the gateway 208, and at 262, the gateway 208 may forward the encrypted data to the protected service 210. That is, steps 256, 258, 260, and/or 262 of the method 200 include no encryption or decryption process, and instead, the data is merely copied and forwarded, as the client proxy 206 and the gateway 208 are operating as TCP proxies (or UDP proxies).

FIG. 2B illustrates an end-to-end encrypted channel 264 established between the browser 204 and the protected service 210. That is, when using the encrypted channel 264, the encryption and/or decryption is being handled by the browser 204 and/or the protected service 210, and the client proxy 206 and/or the gateway 208 are merely copying and forwarding data to and/or from the browser 204 and/or the protected service 210. That is, at 266, the browser may send encrypted data to the client proxy 206, at 268 the client proxy 206 may copy the encrypted data from a first connection between the browser 204 and the client proxy 206 to a second connection between the client proxy 206 and the gateway 208, and at 270, the client proxy 206 may send the copied encrypted data to the gateway 208 via the second connection. At 272, the gateway 208 may copy the encrypted data from the second connection to a third connection between the gateway 208 and the protected service 210, and at 274, the gateway 208 may send the copied encrypted data to the protected service 210 via the third connection. In some examples, the first connection, the second connection, and/or the third connection may be unencrypted connections (e.g., TCP connections or UDP connections) since the application traffic is already encrypted by the browser 204 and/or the protected service 210.

In examples where the application (browser 204 and/or protected service 210) does not use a secure transport mechanism, such as, for example, HTTP, the client proxy 206 may need to create an encrypted tunnel to secure the communication to the gateway 208. For example, the gateway 208 would be configured to decrypt the outer tunnel, retrieve the payload, and send the payload to the server hosting the protected service 210. Additionally, or alternatively, in the reverse direction, the gateway 208 may receive plain traffic from the server and send the traffic back to the client proxy 206 on the encrypted tunnel. In some examples, the client proxy 206 may decrypt the outer tunnel and may send clear (e.g., unencrypted) traffic from the server to the client application (e.g., the browser 204).

Additionally, or alternatively, in examples where application traffic needs to be inspected on the gateway 208, the inner encryption may be between the client application (e.g., the browser 204) and the gateway 208. The gateway 208 would be configured to decrypt the traffic, perform inspect, re-encrypt the traffic, and send the traffic to the server hosting the protected service 210. Additionally, or alternatively, the connections carrying data between the client proxy 206 and the gateway 208 may be optimized by using session resumption tickets that may be exchanged as a part of the control connection.

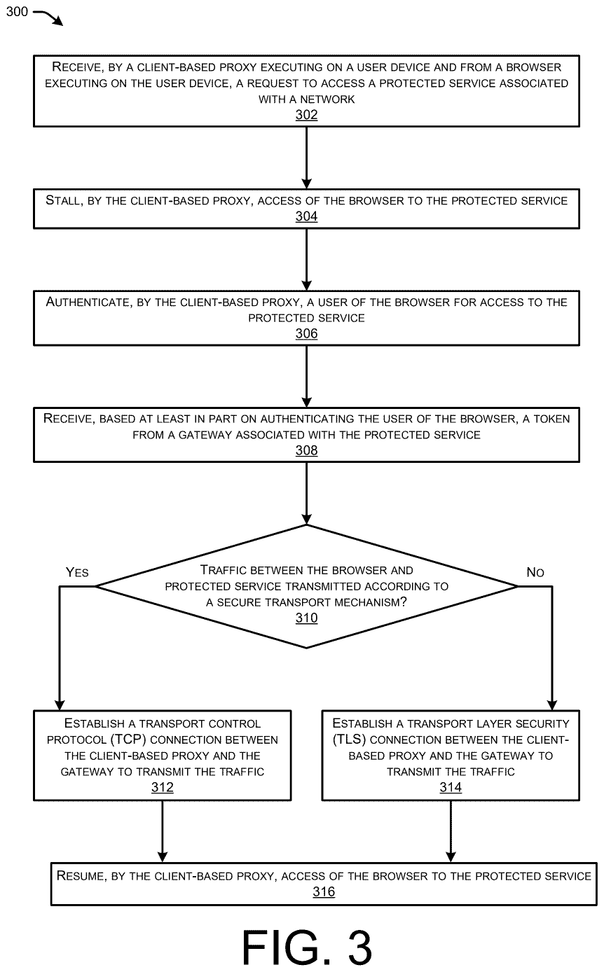

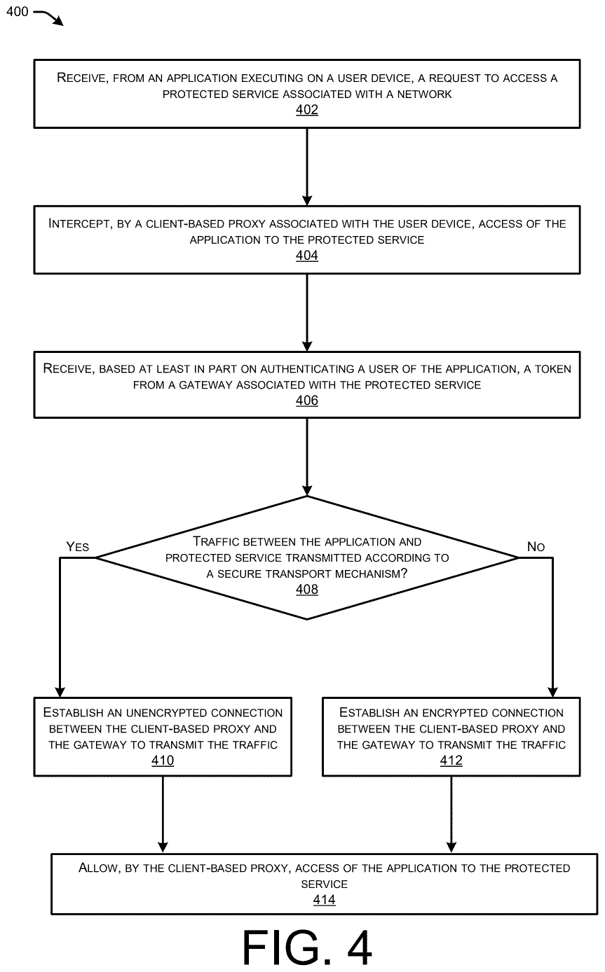

FIGS. 3 and 4 illustrate flow diagrams of example methods 300 and 400 and that illustrate aspects of the functions performed at least partly by the network 102 and/or by the respective components within as described in FIG. 1. The logical operations described herein with respect to FIGS. 3 and 4 may be implemented (1) as a sequence of computer-implemented acts or program modules running on a computing system and/or (2) as interconnected machine logic circuits or circuit modules within the computing system. In some examples, the method(s) 300 and 400 may be performed by a system comprising one or more processors and one or more non-transitory computer-readable media storing computer-executable instructions that, when executed by the one or more processors, cause the one or more processors to perform the method(s) 300 and 400.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 3 and 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 3 illustrates a flow diagram of an example method 300 for eliminating double encryption of network traffic between client(s) and protected service(s) based on transport mechanisms utilized by the client(s) and the protected service(s).

At 302, the method 300 may include receiving, by a client-based proxy executing on a user device and from a browser executing on the user device, a request to access a protected service associated with a network. In some examples, the client-based proxy, the user device, the browser, the protected service, and/or the network may correspond to the client-based proxy 114, the client device 108, the browser 106, the protected service 104, and/or the network 102, as described with respect to FIG. 1. Additionally, or alternatively, the client-based proxy, the browser, and/or the protected service may correspond to the client-based proxy 206, the browser 204, and/or the protected service 210, as described with respect to FIGS. 2A and 2B.

At 304, the method 300 may include stalling, by the client-based proxy, access of the browser to the protected service.

At 306, the method 300 may include authenticating, by the client-based proxy, a user of the browser for access to the protected service.

At 308, the method 300 may include receiving, based at least in part on authenticating the user of the browser, a token from a gateway associated with the network. In some examples, the gateway may correspond to the gateway 112 and/or gateway 208, as described with respect to FIGS. 1 and 2A/2B, respectively. Additionally, or alternatively, the gateway may be associated with the protected service or a different controller.

At 310, the method 300 may include determining whether traffic between the browser and the protected service is transmitted according to a secure transport mechanism. In examples, where it is determined that traffic between the browser and the protected service is transmitted according to a secure transport mechanism, the method 300 may proceed to 312. Additionally, or alternatively, in examples where it is determined that traffic between the browser and the protected service is transmitted according to an unsecure transport mechanism, the method 300 may proceed to 314.

At 312, the method 300 may include establishing, by the client-based proxy and based at least in part on the token, a TCP connection between the client-based proxy and the gateway to transmit the traffic between the browser and the protected service.

At 314, the method 300 may include establishing, by the client-based proxy and based at least in part on the token, a transport layer security (TLS) connection between the client-based proxy and the gateway to transmit the traffic between the browser and the protected service.

At 316, the method 300 may include resuming, by the client-based proxy, access of the browser to the protected service.

Additionally, or alternatively, the method 300 may include receiving encrypted data from the browser destined to the protected service. Additionally, or alternatively, the method 300 may include forwarding the encrypted data to the gateway via the TCP connection. In some examples, the gateway may be configured to determine whether traffic between the browser and the protected service needs to be inspected prior to forwarding the encrypted data to the protected service. That is, based at least in part on determining that the traffic between the browser and the protected service does not need to be inspected, the gateway may be configured to forward the encrypted data to the protected service via a TCP connection. Additionally, or alternatively, based at least in part on determining that the traffic between the browser and the protected service needs to be inspected the gateway may be configured to decrypt the encrypted data to determine unencrypted data corresponding to the encrypted data. Additionally, or alternatively, the gateway may be configured to inspect the unencrypted data. For example, the gateway may leverage an intrusion prevention service (IPS), an intrusion detection service (IDS), and/or the like. In some examples, following inspection, the gateway may be configured to re-encrypt the unencrypted data prior to sending to the protected service.

Additionally, or alternatively, the method 300 may include determining that the traffic between the browser and the protected service is transmitted according to the secure transport mechanism. Additionally, or alternatively, the method 300 may include based at least in part on determining that the traffic between the browser and the protected service is transmitted according to the secure transport mechanism, establishing the TCP connection between the client-based proxy and the gateway.

Additionally, or alternatively, the method 300 may include determining that the traffic between the browser and the protected service is transmitted according to an unsecure transport mechanism. Additionally, or alternatively, the method 300 may include based at least in part on determining that the traffic between the browser and the protected service is transmitted according to the unsecure transport mechanism, establishing the TLS connection between the client-based proxy and the gateway.

In some examples, the secure transport mechanism may comprise at least one of a hypertext transfer protocol secure (HTTPS) or secure shell (SSH) protocol.

In some examples, the gateway may be configured as at least one of a zero-trust network access (ZTNA) gateway or a secure internet gateway (SIG).

FIG. 4 illustrates a flow diagram of another example method 400 for eliminating double encryption of network traffic between client(s) and protected service(s) based on transport mechanisms utilized by the client(s) and the protected service(s).

At 402, the method 400 may include receiving, from an application executing on a user device, a request to access a protected service associated with a network. In some examples, the user device, the application, the protected service, and/or the network may correspond to the client device 108, the browser 106, the protected service 104, and/or the network 102, as described with respect to FIG. 1. Additionally, or alternatively, the browser, and/or the protected service may correspond to the browser 204 and/or the protected service 210, as described with respect to FIGS. 2A and 2B.

At 404, the method 400 may include intercepting, by a client-based proxy associated with the user device, access of the application to the protected service. In some examples, the client-based proxy may correspond to the client-based proxy 114 and/or the client-based proxy 206, as described with respect to FIGS. 1 and/or 2A/2B, respectively.

At 406, the method 400 may include receiving, based at least in part on authenticating a user of the application, a token from a gateway associated with the network. In some examples, the gateway may correspond to the gateway 112 and/or gateway 208, as described with respect to FIGS. 1 and 2A/2B, respectively. Additionally, or alternatively, the gateway may be associated with the protected service or another network controller.

At 408, the method 400 may include determining whether traffic between the browser and the protected service is transmitted according to a secure transport mechanism. In examples, where it is determined that traffic between the browser and the protected service is transmitted according to a secure transport mechanism, the method 400 may proceed to 410. Additionally, or alternatively, in examples where it is determined that traffic between the browser and the protected service is transmitted according to an unsecure transport mechanism, the method 400 may proceed to 412.

At 410, the method 400 may include establishing an unencrypted connection between the client-based proxy and the gateway to transmit the traffic between the application and the protected service.

At 412, the method 400 may include establishing an encrypted connection between the client-based proxy and the gateway to transmit the traffic between the application and the protected service.

At 414, the method 400 may include allowing, by the client-based proxy, access of the application to the protected service.

Additionally, or alternatively, the method 400 may include receiving encrypted data from the application destined to the protected service. Additionally, or alternatively, the method 400 may include forwarding the encrypted data to the gateway via the unencrypted connection. In some examples, the gateway may be configured to determine whether traffic between the application and the protected service needs to be inspected prior to forwarding the encrypted data to the protected service. That is, based at least in part on determining that the traffic between the application and the protected service does not need to be inspected, the gateway may be configured to forward the encrypted data to the gateway via the unencrypted connection. Additionally, or alternatively, based at least in part on determining that the traffic between the application and the protected service needs to be inspected, the gateway may be configured to decrypt the encrypted data to determine unencrypted data corresponding to the encrypted data. Additionally, or alternatively, the gateway may be configured to inspect the unencrypted data. For example, the gateway may leverage an intrusion prevention service (IPS), an intrusion detection service (IDS), and/or the like. In some examples, following inspection, the gateway may be configured to re-encrypt the unencrypted data prior to sending to the protected service.

Additionally, or alternatively, the method 400 may include determining that the traffic between the application and the protected service is transmitted according to the secure transport mechanism. Additionally, or alternatively, the method 400 may include based at least in part on determining that the traffic between the application and the protected service is transmitted according to the secure transport mechanism, establishing the unencrypted connection between the client-based proxy and the gateway.

Additionally, or alternatively, the method 400 may include determining that the traffic between the application and the protected service is transmitted according to an unsecure transport mechanism. Additionally, or alternatively, the method 400 may include based at least in part on determining that the traffic between the application and the protected service is transmitted according to the unsecure transport mechanism, establishing the encrypted connection between the client-based proxy and the gateway.

In some examples, the secure transport mechanism may comprise at least one of a hypertext transfer protocol secure (HTTPS) or secure shell (SSH) protocol.

Additionally, or alternatively, the method 400 may include receiving unencrypted data from the application destined to the protected service. Additionally, or alternatively, the method 400 may include forwarding the unencrypted data to the gateway via the encrypted connection. In some examples, the gateway may be configured to determine whether traffic between the application and the protected service needs to be inspected prior to forwarding the unencrypted data to the protected service. That is, based at least in part on determining that the traffic between the application and the protected service does not need to be inspected, the gateway may be configured to forward the unencrypted data to the gateway via an encrypted connection. Additionally, or alternatively, based at least in part on determining that the traffic between the application and the protected service needs to be inspected, the gateway may be configured to inspect the unencrypted data. For example, the gateway may leverage an intrusion prevention service (IPS), an intrusion detection service (IDS), and/or the like to inspect the unencrypted data. Once the inspection is complete, the gateway may be configured to forward the unencrypted data to the protected service via an encrypted connection.

In some examples, the encrypted connection may be configured as a transport layer security (TLS) connection and/or the unencrypted connection may be configured as one of a transport control protocol (TCP) connection or a uniform datagram protocol (UDP) connection.

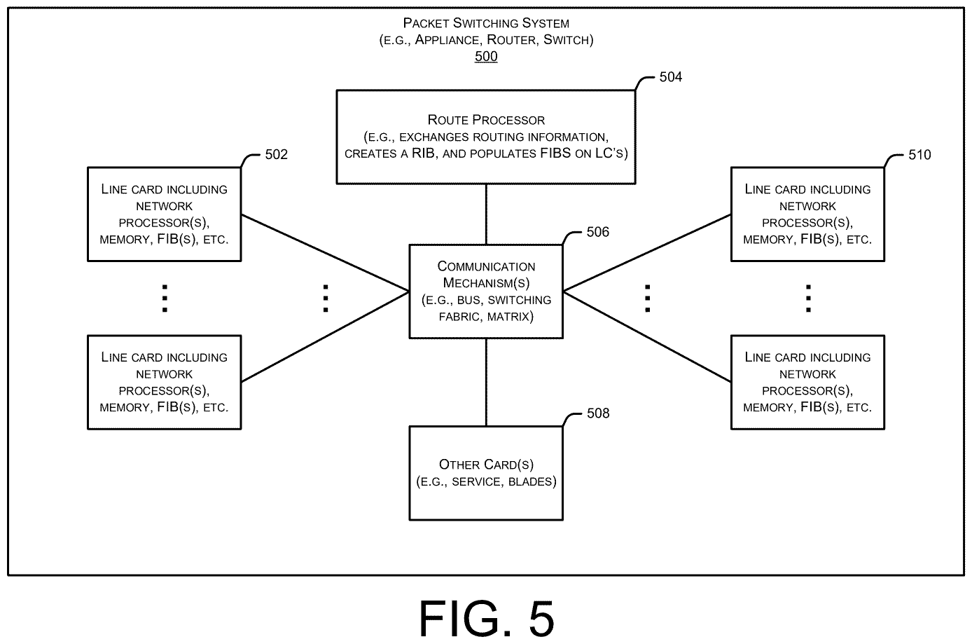

FIG. 5 illustrates a block diagram illustrating an example packet switching device (or system) 500 that can be utilized to implement various aspects of the technologies disclosed herein. In some examples, packet switching device(s) 500 may be employed in various networks, such as, for example, the network 102 as described with respect to FIG. 1.

In some examples, a packet switching device 500 may comprise multiple line card(s) 502, 510, each with one or more network interfaces for sending and receiving packets over communications links (e.g., possibly part of a link aggregation group). The packet switching device 500 may also have a control plane with one or more processing elements 504 for managing the control plane and/or control plane processing of packets associated with forwarding of packets in a network. The packet switching device 500 may also include other cards 508 (e.g., service cards, blades) which include processing elements that are used to process (e.g., forward/send, drop, manipulate, change, modify, receive, create, duplicate, apply a service) packets associated with forwarding of packets in a network. The packet switching device 500 may comprise hardware-based communication mechanism 506 (e.g., bus, switching fabric, and/or matrix, etc.) for allowing its different entities 502, 504, 508 and 510 to communicate. Line card(s) 502, 510 may typically perform the actions of being both an ingress and/or an egress line card 502, 510, in regard to multiple other particular packets and/or packet streams being received by, or sent from, packet switching device 500.

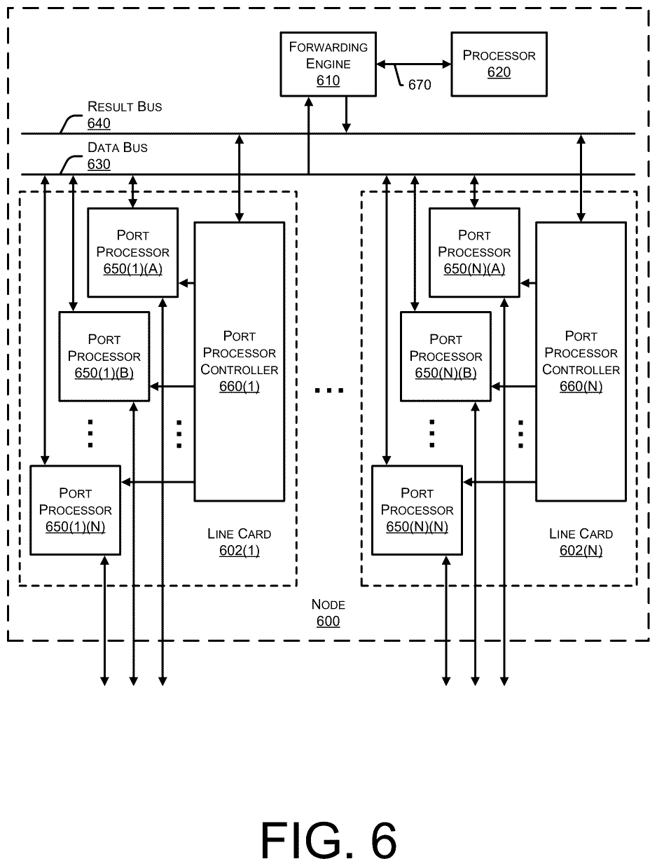

FIG. 6 illustrates a block diagram illustrating certain components of an example node 600 that can be utilized to implement various aspects of the technologies disclosed herein. In some examples, node(s) 600 may be employed in various networks, such as, for example, the network 102 as described with respect to FIG. 1.

In some examples, node 600 may include any number of line cards 602 (e.g., line cards 602(1)-(N), where N may be any integer greater than 1) that are communicatively coupled to a forwarding engine 610 (also referred to as a packet forwarder) and/or a processor 620 via a data bus 630 and/or a result bus 640. Line cards 602(1)-(N) may include any number of port processors 650(1)(A)-(N)(N) which are controlled by port processor controllers 660(1)-(N), where N may be any integer greater than 1. Additionally, or alternatively, forwarding engine 610 and/or processor 620 are not only coupled to one another via the data bus 630 and the result bus 640, but may also communicatively coupled to one another by a communications link 670.

The processors (e.g., the port processor(s) 650 and/or the port processor controller(s) 660) of each line card 602 may be mounted on a single printed circuit board. When a packet or packet and header are received, the packet or packet and header may be identified and analyzed by node 600 (also referred to herein as a router) in the following manner. Upon receipt, a packet (or some or all of its control information) or packet and header may be sent from one of port processor(s) 650(1)(A)-(N)(N) at which the packet or packet and header was received and to one or more of those devices coupled to the data bus 630 (e.g., others of the port processor(s) 650(1)(A)-(N)(N), the forwarding engine 610 and/or the processor 620). Handling of the packet or packet and header may be determined, for example, by the forwarding engine 610. For example, the forwarding engine 610 may determine that the packet or packet and header should be forwarded to one or more of port processors 650(1)(A)-(N)(N). This may be accomplished by indicating to corresponding one(s) of port processor controllers 660(1)-(N) that the copy of the packet or packet and header held in the given one(s) of port processor(s) 650(1)(A)-(N)(N) should be forwarded to the appropriate one of port processor(s) 650(1)(A)-(N)(N). Additionally, or alternatively, once a packet or packet and header has been identified for processing, the forwarding engine 610, the processor 620, and/or the like may be used to process the packet or packet and header in some manner and/or maty add packet security information in order to secure the packet. On a node 600 sourcing such a packet or packet and header, this processing may include, for example, encryption of some or all of the packet's or packet and header's information, the addition of a digital signature, and/or some other information and/or processing capable of securing the packet or packet and header. On a node 600 receiving such a processed packet or packet and header, the corresponding process may be performed to recover or validate the packet's or packet and header's information that has been secured.

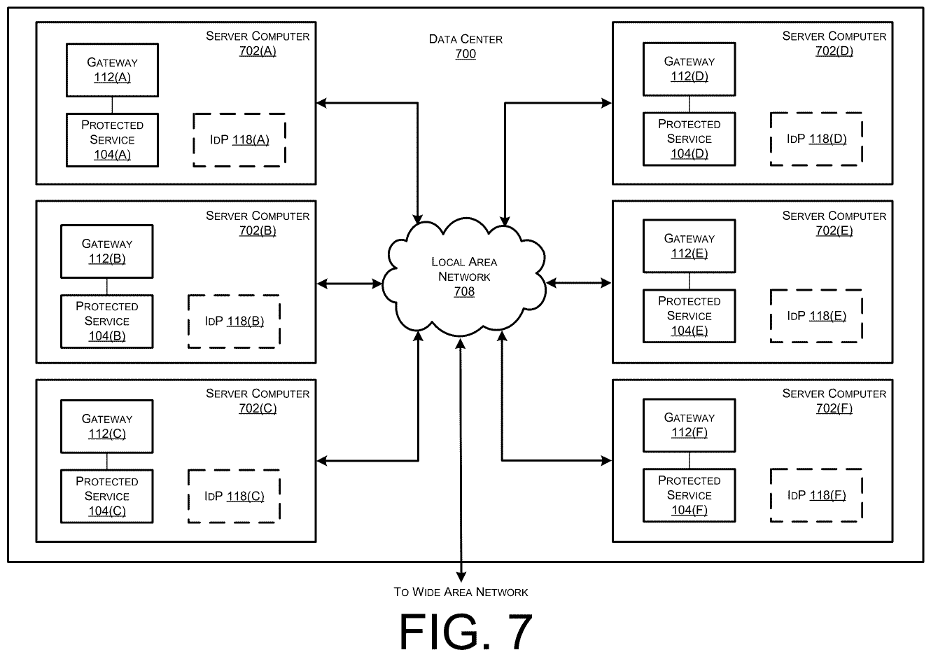

FIG. 7 is a computing system diagram illustrating a configuration for a data center 700 that can be utilized to implement aspects of the technologies disclosed herein. The example data center 700 shown in FIG. 7 includes several server computers 702A-702E (which might be referred to herein singularly as “a server computer 702” or in the plural as “the server computers 702”) for providing computing resources. In some examples, the server computers 702 may include, or correspond to, the servers associated with the site (or data center) 104, the packet switching system 500, and/or the node 600 described herein with respect to FIGS. 1, 5 and 6, respectively.

The server computers 702 can be standard tower, rack-mount, or blade server computers configured appropriately for providing the computing resources described herein. As mentioned above, the computing resources provided by the computing resource network 102 can be data processing resources such as VM instances or hardware computing systems, database clusters, computing clusters, storage clusters, data storage resources, database resources, networking resources, and others. Some of the servers 702 can also be configured to execute a resource manager capable of instantiating and/or managing the computing resources. In the case of VM instances, for example, the resource manager can be a hypervisor or another type of program configured to enable the execution of multiple VM instances on a single server computer 702. Server computers 702 in the data center 700 can also be configured to provide network services and other types of services.

In the example data center 700 shown in FIG. 7, an appropriate LAN 708 is also utilized to interconnect the server computers 702A-702E. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 700, between each of the server computers 702A-702E in each data center 700, and, potentially, between computing resources in each of the server computers 702. It should be appreciated that the configuration of the data center 700 described with reference to FIG. 7 is merely illustrative and that other implementations can be utilized.

In some examples, the server computers 702 may execute and/or host a gateway 112, a protected service 104, and/or an IdP 118.

In some instances, the network 102 may provide computing resources, like application containers, VM instances, and storage, on a permanent or an as-needed basis. Among other types of functionality, the computing resources provided by the network 102 may be utilized to implement the various services described above. The computing resources provided by the network 102 can include various types of computing resources, such as data processing resources like application containers and VM instances, data storage resources, networking resources, data communication resources, network services, and the like.

Each type of computing resource provided by the network 102 can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The network 102 can also be configured to provide other types of computing resources not mentioned specifically herein.

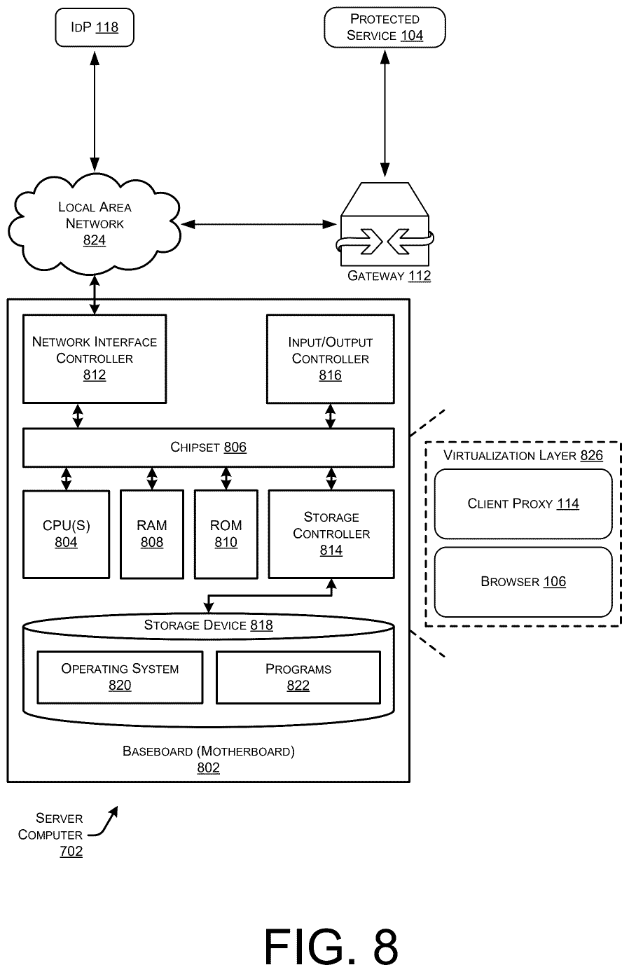

The computing resources provided by the network 102 may be enabled in one embodiment by one or more data centers 700 (which might be referred to herein singularly as “a data center 700” or in the plural as “the data centers 700”). The data centers 700 are facilities utilized to house and operate computer systems and associated components. The data centers 700 typically include redundant and backup power, communications, cooling, and security systems. The data centers 700 can also be located in geographically disparate locations. One illustrative embodiment for a data center 700 that can be utilized to implement the technologies disclosed herein will be described below with regard to FIG. 8.

FIG. 8 shows an example computer architecture for a computing device (or network routing device) 702 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computing device 702 may, in some examples, correspond to a physical server of a data center 104, the packet switching system 500, and/or the node 600 described herein with respect to FIGS. 1, 5, and 6, respectively.

The computing device 702 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computing device 702.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computing device 702. The chipset 806 can further provide an interface to a computer-readable storage medium such as a read-only memory (“ROM”) 810 or non-volatile RAM (“NVRAM”) for storing basic routines that help to startup the computing device 702 and to transfer information between the various components and devices. The ROM 810 or NVRAM can also store other software components necessary for the operation of the computing device 702 in accordance with the configurations described herein.

The computing device 702 can operate in a networked environment using logical connections to remote computing devices and computer systems through a network, such as the network 824 (or 708). The chipset 806 can include functionality for providing network connectivity through a NIC 812, such as a gigabit Ethernet adapter. The NIC 812 is capable of connecting the computing device 702 to other computing devices over the network 824. It should be appreciated that multiple NICs 812 can be present in the computing device 702, connecting the computer to other types of networks and remote computer systems.

The computing device 702 can be connected to a storage device 818 that provides non-volatile storage for the computing device 702. The storage device 818 can store an operating system 820, programs 822, and data, which have been described in greater detail herein. The storage device 818 can be connected to the computing device 702 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 702 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computing device 702 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 702 can further read information from the storage device 818 by detecting the physical states or characteristics of one or more particular locations within the physical storage units.

In addition to the mass storage device 818 described above, the computing device 702 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 702. In some examples, the operations performed by the network 102, and or any components included therein, may be supported by one or more devices similar to computing device 702. Stated otherwise, some or all of the operations performed by the network 102, and or any components included therein, may be performed by one or more computing device 702 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computing device 702. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computing device 702.

In one embodiment, the storage device 818 or other computer-readable storage media is encoded with computer-executable instructions which, when loaded into the computing device 702, transform the computer from a general-purpose computing system into a special-purpose computer capable of implementing the embodiments described herein. These computer-executable instructions transform the computing device 702 by specifying how the CPUs 804 transition between states, as described above. According to one embodiment, the computing device 702 has access to computer-readable storage media storing computer-executable instructions which, when executed by the computing device 702, perform the various processes described above with regard to FIGS. 2A-4. The computing device 702 can also include computer-readable storage media having instructions stored thereupon for performing any of the other computer-implemented operations described herein.

The computing device 702 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computing device 702 might not include all of the components shown in FIG. 8, can include other components that are not explicitly shown in FIG. 8, or might utilize an architecture completely different than that shown in FIG. 8.

The server computer 702 may support a virtualization layer 826, such as one or more components associated with the network 102, such as, for example, the client proxy 114 and/or the browser 106. The browser 204 may leverage the client proxy 114 to establish a connection with a protected service 104 hosted behind a gateway 112. In some examples, the connection may be established in such a way that double encryption and/or decryption of network traffic between the browser 106 and/or the protected service 104 is eliminated, according to the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A system comprising:
one or more processors; and
one or more computer-readable media storing computer-executable instructions that, when executed by the one or more processors, cause the one or more processors to perform operations comprising:
receiving, by a client-based proxy executing on a user device and from a browser executing on the user device, a request to access a protected service associated with a network;
stalling, by the client-based proxy, access of the browser to the protected service;
authenticating, by the client-based proxy, a user of the browser for access to the protected service;
receiving, based at least in part on authenticating the user of the browser, a token from a gateway associated with the protected service;
determining, by the client-based proxy, whether traffic between the browser and the protected service is transmitted according to a secure transport mechanism;
based at least in part on determining whether traffic between the browser and the protected service is transmitted according to the secure transport mechanism, one of:
establishing, by the client-based proxy and based at least in part on the token, a TCP connection between the client-based proxy and the gateway to transmit the traffic between the browser and the protected service; or
establishing, by the client-based proxy and based at least in part on the token, a transport layer security (TLS) connection between the client-based proxy and the gateway to transmit the traffic between the browser and the protected service; and
resuming, by the client-based proxy, access of the browser to the protected service.

2. The system of claim 1, the operations further comprising:
receiving encrypted data from the browser destined to the protected service; and
forwarding the encrypted data to the gateway via the TCP connection, wherein the gateway is configured to determine whether traffic between the browser and the protected service needs to be inspected prior to forwarding the encrypted data to the protected service.

3. The system of claim 1, the operations further comprising:
determining that the traffic between the browser and the protected service is transmitted according to the secure transport mechanism; and
based at least in part on determining that the traffic between the browser and the protected service is transmitted according to the secure transport mechanism, establishing the TCP connection between the client-based proxy and the gateway.

4. The system of claim 1, the operations further comprising:
determining that the traffic between the browser and the protected service is transmitted according to an unsecure transport mechanism; and
based at least in part on determining that the traffic between the browser and the protected service is transmitted according to the unsecure transport mechanism, establishing the TLS connection between the client-based proxy and the gateway.

5. The system of claim 1, wherein the secure transport mechanism comprises at least one of a hypertext transfer protocol secure (HTTPS) or secure shell (SSH) protocol.

6. The system of claim 1, wherein the gateway is configured as at least one of:
a zero-trust network access (ZTNA) gateway; or
a secure internet gateway (SIG).

7. A method comprising:
receiving, from an application executing on a user device, a request to access a protected service associated with a network;
intercepting, by a client-based proxy associated with the user device, access of the application to the protected service;
receiving, based at least in part on authenticating a user of the application, a token from a gateway associated with the network;
determining whether traffic between the application and the protected service is transmitted according to a secure transport mechanism;
based at least in part on determining whether traffic between the application and the protected service is transmitted according to a secure transport mechanism, one of:
establishing an unencrypted connection between the client-based proxy and the gateway to transmit the traffic between the application and the protected service; or
establishing an encrypted connection between the client-based proxy and the gateway to transmit the traffic between the application and the protected service; and
allowing, by the client-based proxy, access of the application to the protected service.

8. The method of claim 7, further comprising:
receiving encrypted data from the application destined to the protected service; and
forwarding the encrypted data to the gateway via the unencrypted connection, wherein the gateway is configured to determine whether traffic between the application and the protected service needs to be inspected prior to forwarding the encrypted data to the protected service.

9. The method of claim 7, further comprising:
determining that the traffic between the application and the protected service is transmitted according to the secure transport mechanism; and
based at least in part on determining that the traffic between the application and the protected service is transmitted according to the secure transport mechanism, establishing the unencrypted connection between the client-based proxy and the gateway.

10. The method of claim 7, further comprising:
determining that the traffic between the application and the protected service is transmitted according to an unsecure transport mechanism; and
based at least in part on determining that the traffic between the application and the protected service is transmitted according to the unsecure transport mechanism, establishing the encrypted connection between the client-based proxy and the gateway.

11. The method of claim 7, wherein the secure transport mechanism comprises at least one of a hypertext transfer protocol secure (HTTPS) or secure shell (SSH) protocol.

12. The method of claim 7, further comprising:
receiving unencrypted data from the application destined to the protected service; and
forwarding the unencrypted data to the gateway via the encrypted connection, wherein the gateway is configured to determine whether traffic between the application and the protected service needs to be inspected prior to forwarding the unencrypted data to the protected service.

13. The method of claim 7, wherein the encrypted connection is configured as a transport layer security (TLS) connection and the unencrypted connection is configured as one of a transport control protocol (TCP) connection or a uniform datagram protocol (UDP) connection.

14. A system comprising:
one or more processors; and
one or more computer-readable media storing computer-executable instructions that, when executed by the one or more processors, cause the one or more processors to perform operations comprising:
receiving, from an application executing on a user device, a request to access a protected service associated with a network;
stalling, by a client-based proxy associated with the user device, access of the application to the protected service;
receiving, based at least in part on authenticating a user of the application, a token from a gateway associated with the network;
determining whether traffic between the application and the protected service is transmitted according to a secure transport mechanism;
based at least in part on determining whether traffic between the application and the protected service is transmitted according to a secure transport mechanism, one of:
establishing, based at least in part on the token, an unencrypted connection between the client-based proxy and the gateway to transmit the traffic between the application and the protected service; or
establishing, based at least in part on the token, an encrypted connection between the client-based proxy and the gateway to transmit the traffic between the application and the protected service; and
allowing, by the client-based proxy, access of the application to the protected service.

15. The system of claim 14, further comprising:
receiving encrypted data from the application destined to the protected service; and
forwarding the encrypted data to the gateway via the unencrypted connection, wherein the gateway is configured to determine whether traffic between the application and the protected service needs to be inspected prior to forwarding the encrypted data to the protected service.

16. The system of claim 14, the operations further comprising:
determining that the traffic between the application and the protected service is transmitted according to the secure transport mechanism; and
based at least in part on determining that the traffic between the application and the protected service is transmitted according to the secure transport mechanism, establishing the unencrypted connection between the client-based proxy and the gateway.

17. The system of claim 14, the operations further comprising:
determining that the traffic between the application and the protected service is transmitted according to an unsecure transport mechanism; and
based at least in part on determining that the traffic between the application and the protected service is transmitted according to the unsecure transport mechanism, establishing the encrypted connection between the client-based proxy and the gateway.

18. The system of claim 14, wherein the secure transport mechanism comprises at least one of a hypertext transfer protocol secure (HTTPS) or secure shell (SSH) protocol.

19. The system of claim 14, the operations further comprising:
receiving unencrypted data from the application destined to the protected service; and
forwarding the unencrypted data to the gateway via the encrypted connection, wherein the gateway is configured to determine whether traffic between the application and the protected service needs to be inspected prior to forwarding the unencrypted data to the protected service.

20. The system of claim 14, wherein the encrypted connection is configured as a transport layer security (TLS) connection and the unencrypted connection is configured as one of a transport control protocol (TCP) connection or a uniform datagram protocol (UDP) connection.
